(19) United States
(12) Patent Application Publication
(10) Pub. No.: US 2026/0295720 A1
(43) Pub. Date: Oct. 1, 2026

(54) LASER PROCESSING APPARATUS

(71) Applicant: Tamron Co., Ltd., Saitama (JP)

(72) Inventors: Kazunori KOMORI, Saitama (JP); Masaki Takemoto, Saitama (JP)

(73) Assignee: Tamron Col, Ltd., Saitama (JP)

(21) Appl. No.: 19/261,607

(22) Filed: Jul. 7, 2025

(30) Foreign Application Priority Data
Mar. 25, 2025 (JP) 2025-049666

(51) Int. Cl. B23K 26/06; B23K 26/073

(52) U.S. Cl. CPC B23K 26/0648; B23K 26/0643; B23K 26/0734

(57) ABSTRACT

The present invention adopts a laser processing apparatus including an optical element having: an optical surface A with a focusing shape which has a focal point A at which a circular region is focused to one point; and an optical surface B which is located on an outer peripheral side of the optical surface A, has a focusing shape, and has a focal point B at which an annular region is focused in an annular manner, and a first irradiation point, which is a position where a laser beam is irradiated onto a workpiece, is located on an optical axis on an opposite side of a composite focal point from the focal point A, and a distance along the optical axis from the composite focal point to the first irradiation point is shorter than a distance along the optical axis from the focal point A to the composite focal point.

### CROSS-REFERENCE TO RELATED APPLICATIONS

This application is based on and claims the benefit of priority from Japanese Patent Application No. 2025-049666, filed on Mar. 25, 2025, the entire contents of which are incorporated herein by reference.

### BACKGROUND OF THE INVENTION

### Technical Field

The present invention relates to a laser processing apparatus that processes a workpiece by irradiating the workpiece with a laser beam.

### Related Art

In recent years, laser beams have been widely used for processing various products. A laser beam is focused to one point and irradiated onto a workpiece to rapidly raise the surface temperature of the workpiece, thereby melting or evaporating the irradiated surface of the workpiece. A laser processing apparatus using such a laser beam performs processing such as cutting, drilling, or welding on the workpiece in this way. Since the laser beam is focused to one point, precise and minute processing can be performed at pinpoint locations. Moreover, by using a laser beam having higher energy, it is possible to shorten the processing time and to process high-hardness workpieces which are difficult to process with mechanical tools.

Here, since a laser processing apparatus uses a laser beam for processing, the laser processing apparatus is provided with an optical system. In the optical system of the laser processing apparatus, conventionally adopted configurations include not only a function of focusing the laser beam to one spot point, but also a function of irradiating the laser beam such that the laser beam at the spot has a circular image shape with an energy intensity distribution of a Gaussian or top-hat shape. However, in laser processing that adopts such a conventional spot image shape, there is a problem in that, during cutting, welding, or drilling of a workpiece, the molten workpiece material generated by the laser beam remains on a cut surface or in a hole, resulting in deterioration of the processing quality. Therefore, in recent years, laser processing has been proposed in which an image shape of a laser beam at a spot is formed into an annular shape or an annular shape with a central portion so that molten workpiece material is appropriately blown off and does not remain on a cut surface or in a hole. In particular, it is known that, by forming the image shape of the laser beam at the spot into an “annular shape with a central portion”, spatter generated by melting with the central portion of the laser beam can be significantly suppressed by the annular laser beam, thereby improving processing quality.

In order to form the image shape of the laser beam at the spot into an annular shape with a central portion, for example, JP 2016-068131 A discloses a laser processing apparatus including an optical element having a rotationally symmetric shape with a conical plate portion of uniform thickness that is inclined with respect to the axis of symmetry, and an optical element having a focusing optical section. JP 5602300 B2 discloses a laser processing head in which, by using at least one of a spherical lens and an aspherical lens capable of generating spherical aberration, rays originally located in the central region of the laser beam are inverted to the peripheral region, and rays originally located in the peripheral region of the laser beam are inverted to the central region, thereby forming a caldera-shaped intensity distribution of the laser beam in which the peripheral region has a higher intensity than the central region. JP H04-127254 U discloses a laser hardening apparatus in which a composite lens having different focal lengths at the central portion and the outer peripheral portion is arranged.

However, in the technologies disclosed in JP 2016-068131 A, JP 5602300 B2, and JP H04-127254 U, a plurality of lenses is used to form an image shape which is an “annular shape with a central portion,” resulting in an increase in the size of a head portion incorporating the optical system of the laser processing apparatus. JP 2024-128516 A proposes an optical system of a laser processing apparatus having an optical surface provided with a plurality of regions in which the positions of the focal points on the optical axis are different.

However, in the annular shape with the central portion which is the image shape of the laser beam disclosed in JP 2016-068131 A, JP 5602300 B2, JP H04-127254 U, and JP 2024-128516 A, the irradiation area of the annular portion is relatively larger than the irradiation area of the central portion, and the energy of the incident laser beam is dispersed between the central portion and the annular portion. Here, in laser processing, the portion of the laser beam that contributes to cutting, welding, etc. is the central portion. That is, in order to appropriately perform laser processing while suppressing spatter, it is necessary to increase the energy intensity of the laser beam emitted from the laser oscillator. The inventors of the present invention have found that the laser processing apparatuses disclosed in JP 2016-068131 A, JP 5602300 B2, JP H04-127254 U, and JP 2024-128516 A have the problem of low energy utilization efficiency of the laser beam emitted from the laser oscillator during laser processing.

From the above, in the conventional laser processing apparatus, in order to adjust the energy intensity of the laser beam at the central portion of the spot to a level suitable for laser processing, it is necessary to increase the energy intensity of the laser beam emitted from the laser oscillator. This results in problems such as the occurrence of a thermal lens effect in the optical system and increased difficulty in handling the laser beam. In addition, when the energy intensity of the laser beam emitted from the laser oscillator is enhanced in order to enhance the energy intensity of the laser beam at the central portion of the spot required for laser processing, the energy intensity of the laser beam in the annular portion of the spot also increases proportionally beyond a necessary level, resulting in a problem of economical inefficiency.

The present invention has been made in view of such circumstances. An object of the present invention is to provide a laser processing apparatus capable of appropriately controlling the energy intensity between a central portion and an image shape portion having a spatter suppression effect, thereby enabling appropriate laser processing while sufficiently suppressing spatter.

### SUMMARY OF THE INVENTION

In order to solve the above-described problems, the present inventors have conducted extensive research and have conceived the following invention.

A laser processing apparatus according to the present invention is for processing a workpiece by irradiating a laser beam emitted from a laser oscillator using a multimode laser, wherein an optical system of the laser processing apparatus includes: an optical element having an optical surface A with a focusing shape which has a focal point A at which a circular region centered on an optical axis and including the optical axis is focused to one point on the optical axis; and an optical surface B which is located on an outer peripheral side of the optical surface A, has a focusing shape, and has a focal point B at which an annular region centered on the optical axis is focused in an annular manner around the optical axis on a plane perpendicular to the optical axis at a position of the focal point A, and when a point on the optical axis at which a laser beam emitted from the optical surface A and a laser beam emitted from the optical surface B intersect with substantially a same diameter on the optical axis is defined as a composite focal point, a first irradiation point, which is a position on the optical axis where the laser beam is irradiated onto the workpiece, is located on the optical axis on an opposite side of the composite focal point from the focal point A, and a distance along the optical axis from the composite focal point to the first irradiation point is shorter than a distance along the optical axis from the focal point A to the composite focal point.

### Effect of the Invention

The laser processing apparatus according to the present invention is capable of appropriately controlling the energy intensity between a central portion and an image shape portion having a spatter suppression effect, thereby enabling appropriate laser processing while sufficiently suppressing spatter.

### BRIEF DESCRIPTION OF THE DRAWINGS

FIG. 1 is a schematic cross-sectional view of an optical system (transmission system) in a laser processing apparatus according to a first embodiment;

FIG. 2 is a schematic cross-sectional view of an optical system (reflection system) in the laser processing apparatus according to the first embodiment;

FIGS. 3A to 3C are schematic diagrams illustrating an energy intensity distribution;

FIG. 4 is a schematic cross-sectional view of an optical system in a laser processing apparatus according to a second embodiment;

FIG. 5 is a schematic diagram of the laser processing apparatus;

FIGS. 6A to 6B are schematic cross-sectional views of an optical element in Examples 1 and 2;

FIG. 7 is a diagram illustrating an energy intensity distribution of a laser beam in Example 1;

FIG. 8 is a diagram illustrating an energy intensity distribution of a laser beam in Example 2; and

FIG. 9 is a diagram illustrating an energy intensity distribution of a laser beam in a comparative example.

### DESCRIPTION OF THE EMBODIMENTS

Hereinafter, embodiments of the laser processing apparatus according to the present invention will be described. It should be noted that the following description merely illustrates one aspect, and the present invention is not limited to the contents described below.

The laser processing apparatus according to the present invention processes a workpiece by irradiating it with a laser beam emitted from a laser oscillator using a multimode laser. Here, in the present description, the term “multimode laser” refers to a laser that uses an optical combiner to bundle laser beams emitted from a plurality of laser beam sources into a single laser beam and uses the laser beam. While the laser beam exhibits low quality and a broad spectral width, the multimode laser is capable of achieving high-power output. In contrast, the term “single-mode laser” refers to a laser that uses a laser beam which oscillates only at a single wavelength or in a TEM00 mode, and has high laser beam quality and a narrow spectral width, and therefore is used for optical communication and precision processing. The laser processing apparatus according to the present invention achieves the effects described later by using a laser beam emitted from a laser oscillator which uses a multimode laser.

The optical system of the laser processing apparatus according to the present invention includes an optical element having: an optical surface A with a focusing shape that has a focal point A at which a circular region centered on an optical axis and including the optical axis is focused to one point on the optical axis; and an optical surface B which is located on the outer peripheral side of the optical surface A, has a focusing shape, and has a focal point B at which an annular region, centered on the optical axis, is focused in an annular manner around the optical axis on a plane, which is perpendicular to the optical axis at the position of the focal point A. When a point on the optical axis at which the laser beam emitted from the optical surface A and the laser beam emitted from the optical surface B intersect with substantially the same diameter on the optical axis is defined as a composite focal point, a first irradiation point, which is the position on the optical axis where the laser beam is irradiated onto the workpiece, is located on the optical axis on the opposite side of the composite focal point from the focal point A, and the distance along the optical axis from the composite focal point to the first irradiation point is shorter than the distance along the optical axis from the focal point A to the composite focal point.

As long as the optical element according to the present invention is as described above, the optical surface A and the optical surface B may be formed on the same optical surface of the same optical element, or may be formed on different optical surfaces of the same optical element.

Further, as long as the optical element according to the present invention is as described above, the laser beams emitted from the optical surface A and the optical surface B may be laser beams transmitted through the optical surface A and the optical surface B, or may be laser beams reflected by the optical surface A and the optical surface B.

The light source (laser oscillator) of the laser beam used in the laser processing apparatus can preferably adopt a laser beam that can be used as a multimode laser. In particular, it is preferable to use a fiber laser (wavelength of 1070 nm or 1080 nm) or a disk laser (wavelength of 1030 nm). In a multimode fiber laser, since laser beams emitted from a plurality of light sources (laser diodes) are bundled into one beam using an optical combiner and incident on a fiber for excitation, it is considered that the energy intensity distribution of the laser beam at the position of a focal point where the beams are focused to one point has a top-hat shape. Similarly, in a disk laser, since a pump beam is reflected a plurality of times between an excitation medium and a reflective mirror before being emitted as a laser beam, it is considered that the energy intensity distribution of the laser beam at the position of the focal point where the beams are focused to one point has a top-hat shape. It is considered that in both the fiber laser and the disk laser, the energy intensity distribution before and after the position of the focal point exhibits a Gaussian shape. By using a laser beam having a top-hat energy intensity distribution at the position of the focal point as described above, the effects described later are achieved.

On the other hand, in a single-mode laser, a laser beam emitted from one light source is incident on a fiber for excitation, and thus, the energy intensity distribution of the laser beam at the position of the focal point where the beams are focused to one point has a Gaussian shape. When using a laser beam having a Gaussian energy intensity distribution at the position of the focal point described above, it is difficult to achieve the effects described later.

It should be noted that the laser processing apparatus according to the present invention may include any type of optical system as long as laser processing can be performed. For example, the laser processing apparatus may include a galvanometer optical system provided with a galvanometer mirror. Further, the laser processing apparatus may include an observation system that branches the laser beam using a beam splitter and observes the image shape, energy intensity distribution, and the like of the laser beam irradiated onto the irradiation point of the workpiece.

### First Embodiment

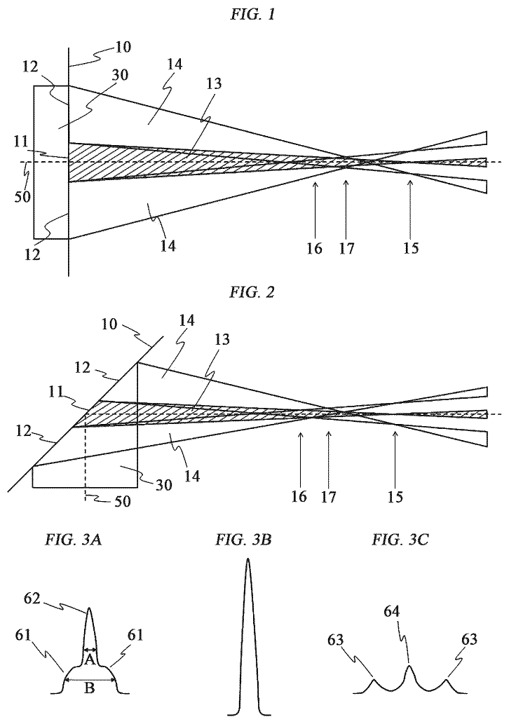

FIGS. 1 and 2 show schematic cross-sectional views in arbitrary orientations of an optical system in the laser processing apparatus according to a first embodiment of the present invention. The optical system in the laser processing apparatus according to the first embodiment includes an optical element 10 having: an optical surface A11 with a focusing shape that has a focal point A at which a circular region centered on an optical axis 50 and including the optical axis 50 is focused to one point on the optical axis; and an optical surface B12 which is located on the outer peripheral side of the optical surface A11, has a focusing shape, and has a focal point B at which an annular region, centered on the optical axis 50, is focused in an annular manner around the optical axis 50 on a plane, which is perpendicular to the optical axis 50 at the position of the focal point A.

FIG. 1 shows the trajectory of laser beams transmitted through and emitted from the optical element 10 when an incident light 30, which is a collimated laser beam, is incident on the optical element 10. The laser beams emitted from the optical surface A11, which is a circular region centered on the optical axis 50 and including the optical axis 50, are focused to one point at a focal point A15 on the optical axis 50, as indicated by a laser beam trajectory 13 (with hatching) shown in FIG. 1. Meanwhile, the laser beams emitted from the optical surface B12 which is located on the outer peripheral side of the optical surface A11 and is an annular region centered on the optical axis 50, are focused in an annular manner around the optical axis 50 on a plane perpendicular to the optical axis 50 at the focal point A15, as indicated by a laser beam trajectory 14 (without hatching) shown in FIG. 1. In FIG. 1, the optical surface A11 and the optical surface B12 may be formed on the same optical surface of the optical element 10 or may be formed on different optical surfaces of the optical element 10. It should be noted that FIG. 1 is a schematic cross-sectional view, and therefore the laser beam trajectory 14 is also shown in a cross-sectional view, and thus, FIG. 1 shows that the laser beams emitted from the optical surface B12 are focused above and below the focal point of the laser beam trajectory 13.

FIG. 2 shows the trajectory of laser beams reflected by and emitted from the optical element 10 when the incident light 30, which is a collimated laser beam, is incident on the optical element 10. The laser beams emitted from the optical surface A11, which is a circular region centered on the optical axis 50 and including the optical axis 50, are focused to one point at the focal point A15 on the optical axis 50, as indicated by the laser beam trajectory 13 (with hatching) shown in FIG. 2. Meanwhile, the laser beams emitted from the optical surface B12, which is located on the outer peripheral side of the optical surface A11 and is an annular region centered on the optical axis 50, are focused in an annular manner around the optical axis 50 on a plane perpendicular to the optical axis 50 at the focal point A15, as indicated by the laser beam trajectory 14 (without hatching) shown in FIG. 2. In FIG. 2, the optical surface A11 and the optical surface B12 may be different optical surfaces of the optical element 10; however, from the viewpoint of the difficulty of configuration, it is preferable that the optical surface A11 and the optical surface B12 are the same optical surface of the optical element 10. It should be noted that FIG. 2 is a schematic cross-sectional view, and therefore the laser beam trajectory 14 is also shown in a cross-sectional view, and thus, FIG. 2 shows that the laser beams emitted from the optical surface B12 are focused above and below the focal point of the laser beam trajectory 13. Further, as long as at least 98% of the incident light 30 is reflected, the optical material of the optical element 10 in FIG. 2 is not particularly limited.

Here, as shown in FIGS. 1 and 2, the point on the optical axis 50 at which the laser beam trajectory 13 emitted from the optical surface A11 and the laser beam trajectory 14 emitted from the optical surface B12 intersect with substantially the same diameter on the optical axis 50 is defined as a composite focal point 17. In this case, a first irradiation point 16, which is the position on the optical axis 50 where the laser beam is irradiated onto the workpiece, is located on the optical axis 50 on the opposite side of the composite focal point 17 from the focal point A15. The distance along the optical axis 50 from the composite focal point 17 to the first irradiation point 16 is shorter than the distance along the optical axis 50 from the focal point A15 to the composite focal point 17.

Thus, since the first irradiation point 16 is located very close to the composite focal point 17, the energy intensity at the central portion of the first irradiation point 16 is close to the energy intensity at the central portion of the composite focal point 17. Here, at the composite focal point 17, the laser beam trajectory 13 emitted from the optical surface A11 and the laser beam trajectory 14 emitted from the optical surface B12 intersect on the optical axis 50 with substantially the same diameter, and thus, the energy intensity of the laser beam at the composite focal point 17 is high. That is, at the first irradiation point 16, laser processing can be performed by efficiently utilizing the energy of the laser beam output from the laser oscillator.

In the first embodiment shown in FIGS. 1 and 2, the first irradiation point 16 is arranged on the side closer to the optical element 10 with respect to the composite focal point 17. The following description will be given with reference to the configuration shown in FIG. 1; however, the subsequent description is also applicable to the configuration shown in FIG. 2.

The image shape of the laser beam at the first irradiation point 16 on a plane perpendicular to the optical axis 50 is formed by overlapping the image formed by the laser beam emitted from the optical surface A11 (indicated by the laser beam trajectory 13) onto the inner portion of the image formed by the laser beam emitted from the optical surface B12 (indicated by the laser beam trajectory 14). For example, in FIG. 1, the laser beam emitted from the optical surface A11 forms a circular image at the central portion, and the laser beam emitted from the optical surface B12 forms an annular image, resulting in an image shape in which the circular image overlaps the inner portion of the annular image. For example, in FIG. 2, the laser beam emitted from the optical surface A11 forms a circular image at the central portion, and the laser beam emitted from the optical surface B12 forms an elliptical annular image, resulting in an image shape in which the circular image overlaps the inner portion of the elliptical annular image.

At the first irradiation point 16, the energy intensity distribution of the laser beam along any straight line intersecting the optical axis 50 on a plane perpendicular to the optical axis 50 is such that: the image formed by the laser beam emitted from the optical surface B12 forms a low energy intensity hill-shaped distribution centered on the optical axis 50; the image formed by the laser beam emitted from the optical surface A11 forms a high energy intensity steep-shaped distribution centered on the optical axis 50; and the high energy intensity steep-shaped distribution centered on the optical axis 50 is spread at the central portion of the low energy intensity hill-shaped distribution centered on the optical axis 50.

Here, a schematic diagram of the energy intensity distribution along any straight line intersecting the optical axis 50 on a plane perpendicular to the optical axis 50 at the first irradiation point 16 is shown in FIG. 3A; a schematic diagram of the energy intensity distribution along any straight line intersecting the optical axis 50 on a plane perpendicular to the optical axis 50 at the composite focal point 17 is shown in FIG. 3B; and a schematic diagram of the energy intensity distribution along any straight line intersecting the optical axis 50 on a plane perpendicular to the optical axis 50 at the focal point A15 is shown in FIG. 3C, respectively. In FIG. 3A, a hill-shaped distribution 61 corresponds to the above-described low energy intensity hill-shaped distribution, and a steep-shaped distribution 62 corresponds to the above-described high energy intensity steep-shaped distribution. In the present description, an image shape having the energy intensity distribution as shown in FIG. 3A at the first irradiation point 16 is referred to as “narrow annular shape with a central portion”. It should be noted that FIGS. 3A, 3B, and 3C are schematic diagrams illustrating the characteristics of the energy intensity distributions at the positions of the first irradiation point 16, the composite focal point 17, and the focal point A15, respectively, and the energy intensity distribution is not limited to the shapes of the energy intensity distributions or the energy intensity levels shown in FIGS. 3A, 3B, and 3C as long as the exhibits distribution the described characteristics.

As described above, the energy intensity at the central portion of the first irradiation point 16 is close to the energy intensity at the central portion of the composite focal point 17. At the first irradiation point 16, the image shape is a “narrow annular shape with a central portion”, exhibiting the energy intensity distribution shown in FIG. 3A. In this case, the laser beam at the “central portion” performs laser processing on the workpiece, and the laser beam in the “narrow annular” portion suppresses spatter. That is, at the first irradiation point 16, an image shape having a spatter suppression effect is provided, and the energy intensity between the central portion and the image shape portion having the spatter suppression effect is in a state of being appropriately controlled. Accordingly, by irradiating the workpiece with the laser beam at the position of the first irradiation point 16, it is possible to perform proper laser processing while sufficiently suppressing spatter, even with a laser beam having a lower energy intensity than in the conventional case of an “annular shape with a central portion”.

Here, in FIG. 3A, when the maximum energy intensity value in the energy intensity distribution is defined as 100%, A represents the energy distribution diameter (μm) at 50% energy intensity, and B represents the energy distribution diameter (μm) at 13.5% energy intensity. In this case, it is preferable to satisfy B/A≥2 in the energy intensity distribution at the first irradiation point 16, more preferably B/A≥2.5, and still more preferably B/A≥3. That is because, by making the energy distribution diameter of the hill-shaped distribution 61 relatively narrower than the energy distribution diameter of the steep-shaped distribution 62, it is possible to perform proper laser processing while sufficiently suppressing spatter, even when using a laser beam with a lower energy intensity than in the conventional case of an “annular shape with a central portion”. When the energy distribution diameter B (μm) at 13.5% energy intensity becomes excessively wide relative to the energy distribution diameter A (μm) at 50% energy intensity, the energy intensity becomes dispersed, making it difficult to perform proper laser processing while suppressing spatter. Therefore, the upper limit of B/A is preferably 5 or less, and more preferably 4.5 or less.

It should be noted that the shape of the hill-shaped distribution 61 shown in FIG. 3A is not limited to the shape shown in FIG. 3A as long as proper laser processing can be performed while sufficiently suppressing spatter even with a laser beam having a lower energy intensity than in the conventional case of an “annular shape with a central portion”, the distribution may have a slightly bimodal peak, and the energy intensity distribution does not necessarily have to be rotationally symmetric with respect to the optical axis.

Next, in FIG. 1, a second irradiation point, which is one of the positions on the optical axis 50 where the laser beam is irradiated onto the workpiece, is located at the focal point A15. The image shape of the laser beam at the second irradiation point (that is, the focal point A15) on a plane perpendicular to the optical axis 50 is formed by overlapping the image formed by the laser beam emitted from the optical surface A11 (indicated by the laser beam trajectory 13) onto the central portion of the void portion of the image formed by the laser beam emitted from the optical surface B12 (indicated by the laser beam trajectory 14). For example, in FIG. 1, the laser beam emitted from the optical surface A11 forms a circular (point-like) image at the central portion, and the laser beam emitted from the optical surface B12 forms an annular image, resulting in an image shape in which the circular (point-like) image overlaps the central portion of the void portion of the annular image. For example, in FIG. 2, the laser beam emitted from the optical surface A11 forms a circular (point-like) image at the central portion, and the laser beam emitted from the optical surface B12 forms an annular (elliptical annular) image, resulting in an image shape in which the circular (point-like) image overlaps the central portion of the void portion of the annular (elliptical annular) image.

At the second irradiation point, the energy intensity distribution of the laser beam along any straight line intersecting the optical axis 50 on a plane perpendicular to the optical axis 50 is such that: the image formed by the laser beam emitted from the optical surface B12 forms a bimodal energy intensity distribution centered on the optical axis 50; the image formed by the laser beam emitted from the optical surface A11 forms a single-peaked energy intensity distribution centered on the optical axis 50; and the single-peaked energy intensity distribution centered on the optical axis 50 is spread at the central portion of the bimodal energy intensity distribution centered on the optical axis 50.

Here, in FIG. 3C, a bimodal distribution 63 corresponds to the above-described bimodal energy intensity distribution, and a single-peaked distribution 64 corresponds to the above-described single-peaked energy intensity distribution. At the second irradiation point, the image shape is a conventional “annular shape with a central portion”, exhibiting the energy intensity distribution shown in FIG. 3C. It should be noted that although the peak value of the single-peaked distribution 64 is illustrated as being higher than the peak value of the bimodal distribution 63 in FIG. 3C, the present invention is not limited thereto. Even when the peak value of the single-peaked distribution 64 is approximately equal to or lower than the peak value of the bimodal distribution 63, such distributions are also included in the energy intensity distribution exhibited by an image shape of an “annular shape with a central portion”.

As described above, since the distance along the optical axis 50 from the composite focal point 17 to the second irradiation point (the focal point A15) is longer than the distance along the optical axis 50 from the composite focal point 17 to the first irradiation point 16, the peak value of the energy intensity distribution at the second irradiation point is lower than the peak value of the energy intensity distribution at the first irradiation point 16. Furthermore, because the energy intensity distribution at the second irradiation point is as shown in FIG. 3C, the energy of the laser beam emitted from the laser oscillator is dispersed between the central portion and the annular portion. Therefore, compared with the case where laser processing is performed at the first irradiation point 16, the intensity of the laser beam emitted from the laser oscillator must be increased in order to perform proper laser processing while suppressing spatter during laser processing.

Next, the point on the optical axis 50 at which the laser beam trajectory 13 emitted from the optical surface A11 and the laser beam trajectory 14 emitted from the optical surface B12 intersect with substantially the same diameter on the optical axis 50 is shown as the composite focal point 17 in FIG. 1. At the composite focal point 17, the image shape of the laser beam on a plane perpendicular to the optical axis 50 is circular, because the laser beam emitted from the optical surface A11 and the laser beam emitted from the optical surface B12 intersect and are combined with substantially the same diameter.

The energy intensity distribution of the laser beam along any straight line intersecting the optical axis 50 on a plane perpendicular to the optical axis 50 at the composite focal point 17 is a Gaussian distribution, as shown in FIG. 3B. It should be noted that the peak value of the Gaussian energy intensity distribution shown in FIG. 3B is high because the laser beams emitted from the optical surface A11 and the optical surface B12 are combined with substantially the same diameter in a narrow area.

In the first embodiment, when the diameter of the laser beam which is incident on the optical element 10 is defined as 100%, the diameter of the optical surface A11 is preferably 10% or more and 25% or less. That is because, by setting the diameter of the optical surface A11 relatively small with respect to the diameter of the incident laser beam in this manner, it is possible to form, at the first irradiation point 16 shown in FIG. 1, a narrow annular image shape with a central portion having an energy intensity distribution as shown in FIG. 3A, thereby achieving the above-described effects.

Further, when the distance from the optical element 10 to the composite focal point 17 is defined as the composite focal length, it is preferable that the absolute value of the distance along the optical axis from the composite focal point 17 to the first irradiation point 16 is 0.015×|composite focal length (mm)| or less. When the first irradiation point 16 is within this range, the first irradiation point 16 is located very close to the composite focal point 17, and thus, the energy intensity at the central portion of the first irradiation point 16 is close to the energy intensity at the central portion of the composite focal point 17. Here, at the composite focal point 17, the laser beam trajectory 13 emitted from the optical surface A11 and the laser beam trajectory 14 emitted from the optical surface B12 intersect on the optical axis 50 with substantially the same diameter, and thus, the energy intensity of the laser beam at the composite focal point 17 is high. That is because, at the first irradiation point 16, the energy of the laser beam output from the laser oscillator can be efficiently utilized. It should be noted that the symbol “| |” denotes the absolute value of the numerical value enclosed therein. Here, the composite focal length (mm) is defined by taking into account the distance from the optical element 10 to the focal point A15 (the focal length (mm) of the optical surface A11) and the distance between the focal point A15 and the composite focal point 17.

FIG. 1 shows the trajectory of laser beams emitted from the optical element 10 when a collimated laser beam is incident on the optical element 10. Generally, a laser beam is emitted radially from an emission end of an optical fiber. Therefore, it is preferable to arrange a collimating lens on the laser oscillator side of the optical element 10, in order to convert the radially emitted laser beam into collimated light.

It should be noted that in the laser processing apparatus according to the first embodiment of the present invention, the optical system is not limited to using collimated light as the incident light to the optical element 10, as long as laser beams having the above-described image shapes and energy intensity distributions at the focal point A15, the first irradiation point 16, and the composite focal point 17 can be obtained using the above-described optical element 10.

By adopting the configuration of the optical system in the laser processing apparatus according to the first embodiment of the present invention as described above, it is possible to obtain an image shape which is a “narrow annular shape with a central portion”, which differs from the conventional image shape which is an “annular shape with a central portion”. By changing the position of the irradiation point, it is also possible to select an image shape which is an “annular shape with a central portion” or an image shape which is a “Gaussian shape”.

### Second Embodiment

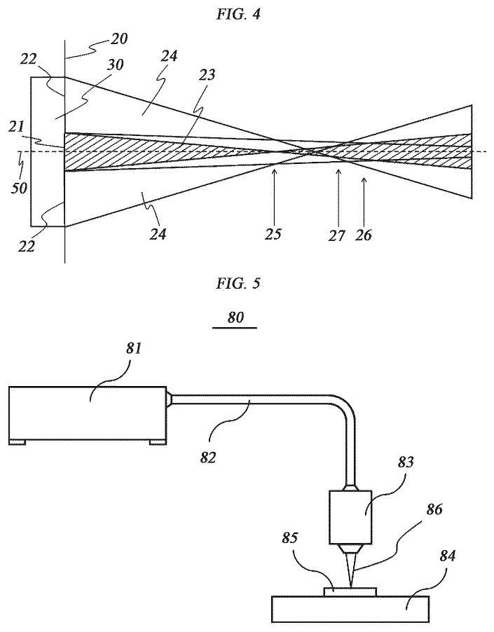

FIG. 4 shows a schematic cross-sectional view in an arbitrary orientation of an optical system in a laser processing apparatus according to a second embodiment of the present invention. The optical system in the laser processing apparatus according to the second embodiment includes an optical element 20 having: an optical surface A21 with a focusing shape that has a focal point A at which a circular region centered on an optical axis 50 and including the optical axis 50 is focused to one point on the optical axis; and an optical surface B22 which is located on the outer peripheral side of the optical surface A21, has a focusing shape, and has a focal point B at which an annular region, centered on the optical axis 50, is focused in an annular manner around the optical axis 50 on a plane, which is perpendicular to the optical axis 50 at the position of the focal point A.

FIG. 4 shows the trajectory of laser beams transmitted through and emitted from the optical element 20 when an incident light 30, which is a collimated laser beam, is incident on the optical element 20. The laser beams emitted from the optical surface A21, which is a circular region centered on the optical axis 50 and including the optical axis 50, are focused to one point at a focal point A25 on the optical axis 50, as indicated by a laser beam trajectory 23 (with hatching) shown in FIG. 4. Meanwhile, the laser beams emitted from the optical surface B22, which is located on the outer peripheral side of the optical surface A21 and is an annular region centered on the optical axis 50, are focused in a circular manner around the optical axis 50 on a plane perpendicular to the optical axis 50 at the focal point A25, as indicated by a laser beam trajectory 24 (without hatching) shown in FIG. 4. In FIG. 4, the optical surface A21 and the optical surface B22 may be formed on the same optical surface of the optical element 20 or may be formed on different optical surfaces of the optical element 20. It should be noted that FIG. 4 is a schematic cross-sectional view, and therefore the laser beam trajectory 24 is also shown in a cross-sectional view, and thus, FIG. 4 shows that the laser beams emitted from the optical surface B22 are focused above and below the focal point of the laser beam trajectory 23.

Although not specifically illustrated, in the second embodiment as well, a configuration may be adopted in which, similar to the first embodiment, when the incident light 30 which is a collimated laser beam is incident on the optical element 20, the laser beam is reflected by the optical element 20 and then emitted.

Here, as shown in FIG. 4, the point on the optical axis 50 at which the laser beam trajectory 23 emitted from the optical surface A21 and the laser beam trajectory 24 emitted from the optical surface B22 intersect with substantially the same diameter on the optical axis 50 is defined as a composite focal point 27. In this case, a first irradiation point 26, which is the position on the optical axis 50 where the laser beam is irradiated onto the workpiece, is located on the optical axis 50 on the opposite side of the composite focal point 27 from the focal point A25. The distance along the optical axis 50 from the composite focal point 27 to the first irradiation point 26 is shorter than the distance along the optical axis 50 from the focal point A25 to the composite focal point 27.

Thus, since the first irradiation point 26 is located very close to the composite focal point 27, the energy intensity at the central portion of the first irradiation point 26 is close to the energy intensity at the central portion of the composite focal point 27. Here, at the composite focal point 27, the laser beam trajectory 23 emitted from the optical surface A21 and the laser beam trajectory 24 emitted from the optical surface B22 intersect on the optical axis 50 with substantially the same diameter, and thus, the energy intensity of the laser beam at the composite focal point 27 is high. That is, at the first irradiation point 26, laser processing can be performed by efficiently utilizing the energy of the laser beam output from the laser oscillator.

In the second embodiment shown in FIG. 4, the first irradiation point 26 is arranged on the side farther from the optical element 20 with respect to the composite focal point 27. The following description will be given with reference to the configuration shown in FIG. 4; however, the subsequent description is also applicable to the configuration in which the incident light 30 is reflected by the optical element 20.

The image shape of the laser beam at the first irradiation point 26 on a plane perpendicular to the optical axis 50 is formed by overlapping the image formed by the laser beam emitted from the optical surface A21 (indicated by the laser beam trajectory 23) onto the inner portion of the image formed by the laser beam emitted from the optical surface B22 (indicated by the laser beam trajectory 24). For example, in FIG. 4, the laser beam emitted from the optical surface A21 forms a circular image at the central portion, and the laser beam emitted from the optical surface B22 forms an annular overlapping image, resulting in an image shape in which the circular image overlaps the inner portion of the annular image.

At the first irradiation point 26, the energy intensity distribution of the laser beam along any straight line intersecting the optical axis 50 on a plane perpendicular to the optical axis 50 is such that: the image formed by the laser beam emitted from the optical surface B22 forms a low energy intensity hill-shaped distribution centered on the optical axis 50; the image formed by the laser beam emitted from the optical surface A21 forms a high energy intensity steep-shaped distribution centered on the optical axis 50; and the high energy intensity steep-shaped distribution centered on the optical axis 50 is spread at the central portion of the low energy intensity hill-shaped distribution centered on the optical axis 50.

Here, a schematic diagram of the energy intensity distribution along any straight line intersecting the optical axis 50 on a plane perpendicular to the optical axis 50 at the first irradiation point 26 is shown in FIG. 3A; a schematic diagram of the energy intensity distribution along any straight line intersecting the optical axis 50 on a plane perpendicular to the optical axis 50 at the composite focal point 27 is shown in FIG. 3B; and a schematic diagram of the energy intensity distribution along any straight line intersecting the optical axis 50 on a plane perpendicular to the optical axis 50 at the focal point A25 is shown in FIG. 3C, respectively. In FIG. 3A, a hill-shaped distribution 61 corresponds to the above-described low energy intensity hill-shaped distribution, and a steep-shaped distribution 62 corresponds to the above-described high energy intensity steep-shaped distribution. At the first irradiation point 26, the image shape is a “narrow annular shape with a central portion”, exhibiting the energy intensity distribution shown in FIG. 3A. It should be noted that FIGS. 3A, 3B, and 3C are schematic diagrams illustrating the characteristics of the energy intensity distributions at the positions of the first irradiation point 26, the composite focal point 27, and the focal point A25, respectively, and the energy intensity distribution is not limited to the shapes of the energy intensity distributions or the energy intensity levels shown in FIGS. 3A, 3B, and 3C as long as the distribution exhibits the described characteristics.

As described above, the energy intensity at the central portion of the first irradiation point 26 is close to the energy intensity portion of the composite focal point 27. At the first irradiation point 26, the image shape is a “narrow annular shape with a central portion”, exhibiting the energy intensity distribution shown in FIG. 3A. In this case, the laser beam at the “central portion” performs laser processing on the workpiece, and the laser beam in the “narrow annular” portion suppresses spatter. That is, at the first irradiation point 26, an image shape having a spatter suppression effect is provided, and the energy intensity between the central portion and the image shape portion having the spatter suppression effect is in a state of being appropriately controlled. Accordingly, by irradiating the workpiece with the laser beam at the position of the first irradiation point 26, it is possible to perform proper laser processing while sufficiently suppressing spatter, even with a laser beam having a lower energy intensity than in the conventional case of a “annular shape with a central portion”.

Here, in FIG. 3A, when the maximum energy intensity value in the energy intensity distribution is defined as 100%, A represents the energy distribution diameter (μm) at 50% energy intensity, and B represents the energy distribution diameter (μm) at 13.5% energy intensity. In this case, it is preferable to satisfy B/A≥2 in the energy intensity distribution at the first irradiation point 16, more preferably B/A≥2.5, and still more preferably B/A≥3. That is because, by making the energy distribution diameter of the hill-shaped distribution 61 relatively narrower than the energy distribution diameter of the steep-shaped distribution 62, it is possible to perform proper laser processing while sufficiently suppressing spatter, even when using a laser beam with a lower energy intensity than in the conventional case of an “annular shape with a central portion”. When the energy distribution diameter B (μm) at 13.5% energy intensity becomes excessively wide relative to the energy distribution diameter A (μm) at 50% energy intensity, the energy intensity becomes dispersed, making it difficult to perform proper laser processing while suppressing spatter. Therefore, the upper limit of B/A is preferably 5 or less, and more preferably 4.5 or less.

It should be noted that the shape of the hill-shaped distribution 61 shown in FIG. 3A is not limited to the shape shown in FIG. 3A as long as proper laser processing can be performed while sufficiently suppressing spatter even with a laser beam having a lower energy intensity than in the conventional case of an “annular shape with a central portion”, the distribution may have a slightly bimodal peak, and the energy intensity distribution does not necessarily have to be rotationally symmetric with respect to the optical axis.

Next, in FIG. 4, a second irradiation point, which is one of the positions on the optical axis 50 where the laser beam is irradiated onto the workpiece, is located at the focal point A25. The image shape of the laser beam at the second irradiation point (that is, the focal point A25) on a plane perpendicular to the optical axis 50 is formed by overlapping the image formed by the laser beam emitted from the optical surface A21 (indicated by the laser beam trajectory 23) onto the central portion of the void portion of the image formed by the laser beam emitted from the optical surface B22 (indicated by the laser beam trajectory 24). For example, in FIG. 4, the laser beam emitted from the optical surface A21 forms a circular (point-like) image at the central portion, and the laser beam emitted from the optical surface B22 forms an annular image, resulting in an image shape in which the circular (point-like) image overlaps the central portion of the void portion of the annular image.

At the second irradiation point, the energy intensity distribution of the laser beam along any straight line intersecting the optical axis 50 on a plane perpendicular to the optical axis 50 is such that: the image formed by the laser beam emitted from the optical surface B22 forms a bimodal energy intensity distribution centered on the optical axis 50; the image formed by the laser beam emitted from the optical surface A21 forms a single-peaked energy intensity distribution centered on the optical axis 50; and the single-peaked energy intensity distribution centered on the optical axis 50 is spread at the central portion of the bimodal energy intensity distribution centered on the optical axis 50.

Here, in FIG. 3C, a bimodal distribution 63 corresponds to the above-described bimodal energy intensity distribution, and a single-peaked distribution 64 corresponds to the above-described single-peaked energy intensity distribution. At the second irradiation point, the image shape is a conventional “annular shape with a central portion”, exhibiting the energy intensity distribution shown in FIG. 3C. It should be noted that although the peak value of the single-peaked distribution 64 is illustrated as being higher than the peak value of the bimodal distribution 63 in FIG. 3C, the present invention is not limited thereto. Even when the peak value of the single-peaked distribution 64 is approximately equal to or lower than the peak value of the bimodal distribution such distributions 63, are also included in the energy intensity distribution exhibited by an image shape of an “annular shape with a central portion”.

As described above, since the distance along the optical axis 50 from the composite focal point 27 to the second irradiation point (the focal point A25) is longer than the distance along the optical axis 50 from the composite focal point 27 to the first irradiation point 26, the peak value of the energy intensity distribution at the second irradiation point is lower than the peak value of the energy intensity distribution at the first irradiation point 26. Furthermore, because the energy intensity distribution at the second irradiation point is as shown in FIG. 3C, the energy of the laser beam emitted from the laser oscillator is dispersed between the central portion and the annular portion. Therefore, compared with the case where laser processing is performed at the first irradiation point 26, the intensity of the laser beam emitted from the laser oscillator must be increased in order to perform proper laser processing while suppressing spatter during laser processing.

Next, the point on the optical axis 50 at which the laser beam trajectory 23 emitted from the optical surface A21 and the laser beam trajectory 24 emitted from the optical surface B22 intersect with substantially the same diameter on the optical axis 50 is shown as the composite focal point 27 in FIG. 4. At the composite focal point 27, the image shape of the laser beam on a plane perpendicular to the optical axis 50 is circular, because the laser beam emitted from the optical surface A21 and the laser beam emitted from the optical surface B22 intersect and are combined with substantially the same diameter.

The energy intensity distribution of the laser beam along any straight line intersecting the optical axis 50 on a plane perpendicular to the optical axis 50 at the composite focal point 27 is a Gaussian distribution, as shown in FIG. 3B. It should be noted that the peak value of the Gaussian energy intensity distribution shown in FIG. 3B is high because the laser beams emitted from the optical surface A21 and the optical surface B22 are combined with substantially the same diameter in a narrow area.

In the second embodiment, when the diameter of the laser beam which is incident on the optical element 20 is defined as 100%, the diameter of the optical surface A21 is preferably 10% or more and 25% or less. That is because, by setting the diameter of the optical surface A21 relatively small with respect to the diameter of the incident laser beam in this manner, it is possible to form, at the first irradiation point 26 shown in FIG. 4, a narrow annular image shape with a central portion having an energy intensity distribution as shown in FIG. 3A.

Further, when the distance from the optical element 20 to the composite focal point 27 is defined as the composite focal length, it is preferable that the absolute value of the distance along the optical axis from the composite focal point 27 to the first irradiation point 26 is 0.015×|composite focal length (mm)| or less. When the first irradiation point 26 is within this range, the first irradiation point 26 is located very close to the composite focal point 27, and thus, the energy intensity at the central portion of the first irradiation point 26 is close to the energy intensity at the central portion of the composite focal point 27. Here, at the composite focal point 27, the laser beam trajectory 23 emitted from the optical surface A21 and the laser beam trajectory 24 emitted from the optical surface B22 intersect on the optical axis 50 with substantially the same diameter, and thus, the energy intensity of the laser beam at the composite focal point 27 is high. That is because, at the first irradiation point 26, the energy of the laser beam output from the laser oscillator can be efficiently utilized. It should be noted that the symbol “| |” denotes the absolute value of the numerical value enclosed therein. Here, the composite focal length (mm) is defined by taking into account the distance from the optical element 20 to the focal point A25 (the focal length (mm) of the optical surface A21) and the distance between the focal point A25 and the composite focal point 27.

FIG. 4 shows the trajectory of laser beams emitted from the optical element 20 when a collimated laser beam is incident on the optical element 20. Generally, a laser beam is emitted radially from an emission end of an optical fiber. Therefore, it is preferable to arrange a collimating lens on the laser oscillator side of the optical element 20, in order to convert the radially emitted laser beam into collimated light.

It should be noted that in the laser processing apparatus according to the second embodiment of the present invention, the optical system is not limited to using collimated light as the incident light to the optical element 20, as long as laser beams having the above-described image shapes and energy intensity distributions at the focal point A25, the first irradiation point 26, and the composite focal point 27 can be obtained using the above-described optical element 20.

By adopting the configuration of the optical system in the laser processing apparatus according to the second embodiment of the present invention as described above, it is possible to obtain an image shape which is a “narrow annular shape with a central portion”, which differs from the conventional image shape which is an “annular shape with a central portion”. By changing the position of the irradiation point, it is also possible to select an image shape which is an “annular shape with a central portion” or an image shape which is a “Gaussian shape”.

### [Laser Processing Apparatus]

The laser processing apparatus according to the present invention includes the optical system of the laser processing apparatus according to the first embodiment or the second embodiment described above. FIG. 5 shows a schematic diagram of the laser processing apparatus according to the present embodiment. A laser processing apparatus 80 includes a laser oscillator 81, an optical path 82, an optical system 83, and a processing stage 84. A workpiece 85 is placed on the processing stage 84. The laser processing apparatus 80 performs laser processing on the workpiece 85 by irradiating the workpiece 85 with a laser beam 86 from the optical system 83. In this case, the laser oscillator 81 is a device that outputs the above-described multimode laser beam used for processing. The optical path 82 transmits the laser beam output from the laser oscillator 81 to the optical system 83 and may be of a type that uses reflection mirrors or a type that uses optical fibers. The optical system 83 adopts the optical system of the laser processing apparatus according to the present invention and irradiates the transmitted laser beam onto the workpiece 85 as the laser beam 86. The processing stage 84 fixes and holds the workpiece 85 in place and includes a device for moving the workpiece 85, the optical system 83, or both, in accordance with movement of the irradiation point on the workpiece 85.

In this case, since the optical system 83 adopts the optical system of the laser processing apparatus according to the present invention, it is possible to form an image shape such as a “narrow annular shape with a central portion”, a “Gaussian shape”, or an “annular shape with a central portion” on a plane perpendicular to the optical axis at the irradiation point of the laser beam 86 on the workpiece 85 by selecting a position along the optical axis.

In particular, in an image shape which is a “narrow annular shape with a central portion”, the energy intensity at the central portion is close to the energy intensity at the central portion of a Gaussian shape at the composite focal point, and the laser beam at the “central portion” performs laser processing on the workpiece, while the laser beam at the “narrow annular” portion suppresses spatter. That is, at the position of the image shape which is a “narrow annular shape with a central portion”, an image shape having a spatter suppression effect is provided, and the energy intensity between the central portion and the image shape portion having the spatter suppression effect is in a state of being appropriately controlled. Accordingly, by selecting the image shape which is a “narrow annular shape with a central portion”, it is possible to perform proper laser processing while sufficiently suppressing spatter, even with a laser beam having a lower energy intensity than in the conventional case of an “annular shape with a central portion”.

The embodiments according to the present invention described above are one aspect of the present invention, and can be appropriately modified without departing from the gist of the present invention. In addition, the present invention will be more specifically described below with reference to Examples, but the present invention is not limited to the following Examples.

### Example 1

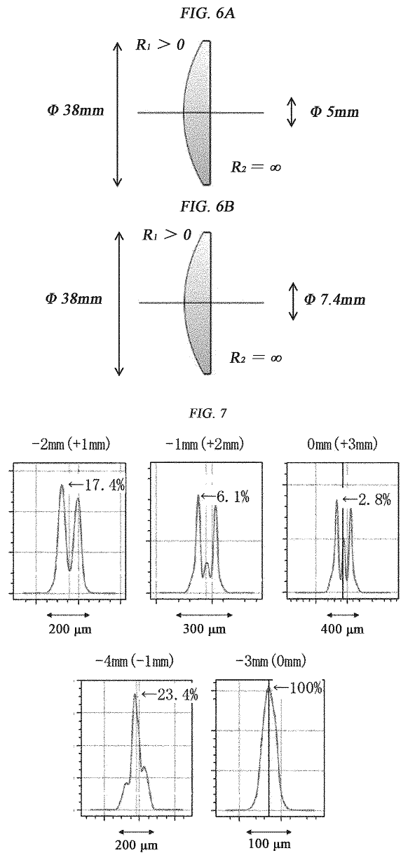

The optical system of the laser processing apparatus of Example 1 adopted the configuration of the first embodiment. In the optical element of Example 1, a plano-convex lens having nd=1.45846 and vd=67.82, and having a diameter (optically effective diameter) of 38 mm, was used. In this optical element, the diameter of the optical surface A was set to φ5 mm (13.2% relative to the diameter of the incident laser beam). FIG. 6A shows a schematic cross-sectional view of the optical element of Example 1. In FIG. 6A, the left side indicates the incident side of the laser beam, and R₁ and R₂ respectively represent the curvature radii of the optical surfaces.

The optical surface of the optical element of Example 1 can be defined by the even-order aspherical equation expressed by the following formula (1).

$$z ( x ) = ( {x}^{2} / r ) / [ 1 + {\{ 1 - ( 1 + κ ) \cdot {x}^{2} / {r}^{2} \}}^{1 / 2} ] + {A}_{2} {x}^{2} + {A}_{4} {x}^{4} + {A}_{6} {x}^{6} + {A}_{8} {x}^{8} \qquad ( 1 )$$

here,
z(x): a surface position in the optical axis direction (sag amount) at a position separated by a distance X perpendicular to the optical axis,
r: curvature radius,
κ: conic constant,
A₂: 2nd-order aspherical coefficient,
A₄: 4th-order aspherical coefficient,
A₆: 6th-order aspherical coefficient,
A₈: 8th-order aspherical coefficient.

The optical surface A of Example 1 is shaped to satisfy the following values when applying the formula (1). In this case, the focal length of the optical surface A is 200 mm.
r: 91.224
κ: −0.2645082
A₂: 0.0
A₄: 0.0
A₆: 0.0
A₈: 0.0

Next, the optical surface B of Example 1 is shaped to satisfy the following values when applying the formula (1). The feature of the optical surface B is that k is extremely large, and a second-order aspherical coefficient, which is rarely used in conventional optical designs, is used. In this case, the optical surface B focuses light in a circular shape around the optical axis on a plane perpendicular to the optical axis at the focal point position of the optical surface A.
r: 91.224
κ: −1201557.6
A₂: 5.47942×10⁻³
A₄: 7.24726×10⁻⁸
A₆: 0.0
A₈: 0.0

As the laser oscillator using a multimode laser, a multimode fiber laser YLR-500 MM-AC (manufactured by IPG Photonics Corporation) (wavelength: 1070 nm, output: 200 W) was used. The laser beam radiated from the optical fiber was converted into collimated light using a collimating lens (focal length: 210 mm), and configured to be incident on the optical element of Example 1. The energy intensity distribution of the laser beam was simulated using OpticStudio, which is provided by Zemax, LLC., along an arbitrary straight line intersecting the optical axis on a plane perpendicular to the optical axis at each position along the optical axis. The simulation results are shown in FIG. 7. In this case, when the energy intensity of the laser beam emitted from the laser oscillator was defined as 100%, the energy intensity of the laser beam transmitted through the optical surface A was 138. In FIG. 7, the vertical axis represents the energy intensity, and the horizontal axis represents the coordinates along an arbitrary straight line including the optical axis on a plane perpendicular to the optical axis. In each graph of FIG. 7, the vertical axis is scaled such that when the peak value of the energy intensity distribution at the position of “−3 mm (0 mm)”, which is 31091.8 kW/cm², was defined as 100%, the peak values of the energy intensity distributions in the other graphs correspond to the intensity values represented by the numerical values noted in the respective graphs. Furthermore, in each graph of FIG. 7, the horizontal axis is scaled according to the width described.

In FIG. 7, the energy intensity distribution at the position corresponding to the focal point A15 is shown in the graph labeled “0 mm (+3 mm)” at the top of the graph. Using this position as a reference, the distances along the optical axis approaching the optical element of Example 1 are indicated by the numerical values at the top of each graph. For example, the graph labeled “−1 mm (+2 mm)” shows the energy intensity distribution at a position 1 mm closer to the optical element of Example 1 than the position corresponding to the focal point A15. In FIG. 7, the position corresponding to the composite focal point 17 is labeled “−3 mm (0 mm)”. The position corresponding to the first irradiation point 16 is labeled “−4 mm (−1 mm)”. It should be noted that the values in parentheses indicate the distances along the optical axis with the composite focal point 17 as the reference (0 mm).

In the graph at the position of “0 mm (+3 mm)”, a single-peaked energy intensity distribution is spread at the central portion of a bimodal energy intensity distribution. That is, the image shape at this position is an “annular shape with a central portion” in which the laser beam emitted from the optical surface A11 forms a circular image at the central portion, and the laser beam emitted from the optical surface B12 forms an annular image, with the circular image overlapping the central portion of the void portion of the annular image. The energy intensity distribution is spread over a diameter of approximately 400 μm.

Next, the graph at the position of “−3 mm (0 mm)” shows a Gaussian energy intensity distribution. That is, the image shape at this position is a “circular” shape in which the laser beam emitted from the optical surface A11 and the laser beam emitted from the optical surface B12 intersect and are combined with substantially the same diameter.

Next, the graph at the position of “−4 mm (−1 mm)” shows a steep-shaped distribution with high energy intensity at the central portion of a hill-shaped distribution with low energy intensity. That is, the image shape at this position is a “narrow annular shape with a central portion” in which the laser beam emitted from the optical surface A11 forms a circular image at the central portion, and the laser beam emitted from the optical surface B12 forms an annular image, with the circular image overlapping the inner portion of the annular image. Furthermore, it was confirmed that the energy intensity distribution is spread over a diameter of approximately 200 μm, and the diameter is smaller and the energy intensity distribution is more concentrated compared to the energy intensity distribution at the position of “0 mm (+3 mm)”. It was also confirmed that this position, which corresponds to the first irradiation point 16, is located only 1 mm closer to the optical element of Example 1 than the position of “−3 mm (0 mm)”, which corresponds to the composite focal point 17.

Here, the position shifted toward the focal point A15, which is “0 mm (+3 mm)”, from the position of “−3 mm (0 mm)”, which corresponds to the composite focal point 17, is “−2 mm (+1 mm)” or “−1 mm (+2 mm)”. Referring to the graphs at the positions of “−2 mm (+1 mm)” and “−1 mm (+2 mm)”, the energy intensity distribution differs from the “energy intensity distribution in which a steep-shaped distribution with high energy intensity is spread at the central portion of a hill-shaped distribution with low energy intensity”, and the image shape of the energy intensity distribution was not a “narrow annular shape with a central portion”. That is, it was confirmed that the first irradiation point at which the image shape which is a “narrow annular shape with a central portion” is obtained is located on the optical axis on the side opposite to the focal point A15 side with respect to the composite focal point 17, and that the distance along the optical axis from the composite focal point 17 to the first irradiation point 16 is shorter than the distance along the optical axis from the focal point A15 to the composite focal point 17.

It should be noted that the absolute value of the distance along the optical axis from the position corresponding to the composite focal point 17 to the position corresponding to the first irradiation point 16 is 1 mm. Here, since the distance from the optical element of Example 1 to the position corresponding to the focal point A15 (the focal length of the optical surface A) is 200 mm, the distance from the optical element of Example 1 to the composite focal point 17, namely the composite focal length (mm), is 200−3=197 mm. In this case, based on the equation 0.015×|197 mm|=2.955 mm, it was confirmed that the absolute value of the distance along the optical axis from the composite focal point 17 to the first irradiation point 16 falls within the range of 0.015×|composite focal length (mm)| or less.

At the first irradiation point “−4 mm (−1 mm)”, when the maximum energy intensity value in the energy intensity distribution was defined as 100%, an energy distribution diameter A (μm) at 50% energy intensity and an energy distribution diameter B (μm) at 13.5% energy intensity yielded B/A=3.3, satisfying the condition B/A≥2.

Furthermore, it was confirmed that when the peak value of the energy intensity distribution at the position of “−3 mm (0 mm)” corresponding to the composite focal point 17 was defined as 100%, the peak value of the energy intensity distribution at the position of “−4 mm (−1 mm)” corresponding to the first irradiation point 16 was as high as 23.4%. On the other hand, the peak value of the energy intensity distribution at the position of “0 mm (+3 mm)” corresponding to the focal point A15 was as low as 2.8%.

### Example 2

The optical system of the laser processing apparatus of Example 2 adopted the configuration of the first embodiment. In the optical element of Example 2, a plano-convex lens having nd=1.45846 and vd=67.82, and having a diameter (optically effective diameter) of 38 mm, was used. In this optical element, the diameter of the optical surface A was set to φ7.4 mm (19.5% relative to the diameter of the incident laser beam). FIG. 6B shows a schematic cross-sectional view of the optical element of Example 2. In FIG. 6B, the left side indicates the incident side of the laser beam, and R₁ and R₂ respectively represent the curvature radii of the optical surfaces.

The optical surface A of Example 2 is shaped to satisfy the following values when applying the formula (1). In this case, the focal length of the optical surface A is 200 mm.
r: 91.224
κ: −0.2645082
A₂: 0.0
A₄: 0.0
A₆: 0.0
A₈: 0.0

Next, the optical surface B of Example 2 is shaped to satisfy the following values when applying the formula (1). The feature of the optical surface B is that k is extremely large, and a second-order aspherical coefficient, which is rarely used in conventional optical designs, is used. In this case, the optical surface B focuses light in a circular shape around the optical 1 axis on a plane perpendicular to the optical axis at the focal point position of the optical surface A.
r: 91.224
κ: −1201557.6
A₂: 5.47942×10⁻³
A₄: 7.24726×10⁻⁸
A₆: 0.0
A₈: 0.0

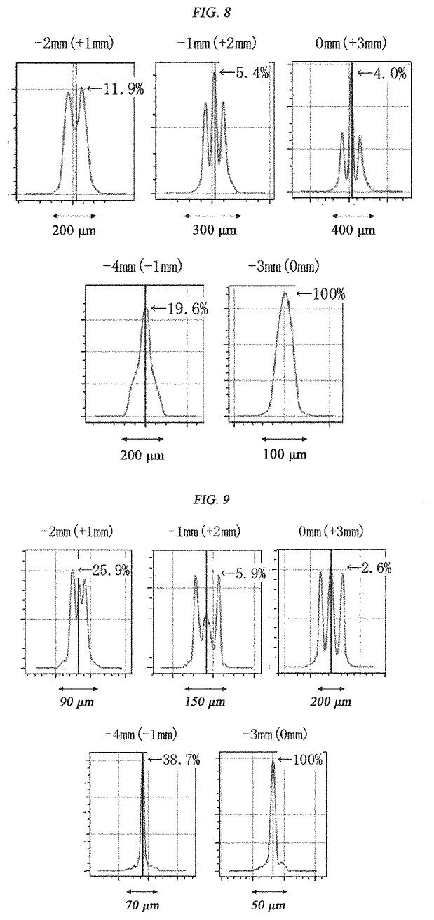

As the laser oscillator using a multimode laser, a multimode fiber laser YLR-500 MM-AC (IPG Photonics Corporation) (wavelength: 1070 nm, output: 500 W) was used. The laser beam radiated from the optical fiber was converted into collimated light using a collimating lens (focal length: 210 mm), and configured to be incident on the optical element of Example 2. The energy intensity distribution of the laser beam was simulated using OpticStudio, which is provided by Zemax, LLC., along an arbitrary straight line intersecting the optical axis on a plane perpendicular to the optical axis at each position along the optical axis. The simulation results are shown in FIG. 8. In this case, when the energy intensity of the laser beam emitted from the laser oscillator was defined as 100%, the energy intensity of the laser beam transmitted through the optical surface A was 26%. In FIG. 8, the vertical axis represents the energy intensity, and the horizontal axis represents the coordinates along an arbitrary straight line including the optical axis on a plane perpendicular to the optical axis. In each graph of FIG. 8, the vertical axis is scaled such that when the peak value of the energy intensity distribution at the position of “−3 mm (0 mm)”, which is 34611.8 kW/cm², was defined as 100%, the peak values of the energy intensity distributions in the other graphs correspond to the intensity values represented by the numerical values noted in the respective graphs. Furthermore, in each graph of FIG. 8, the horizontal axis is scaled according to the width described.

In FIG. 8, the energy intensity distribution at the position corresponding to the focal point A15 is shown in the graph labeled “0 mm (+3 mm)” at the top of the graph. Using this position as a reference, the distances along the optical axis approaching the optical element of Example 2 are indicated by the numerical values at the top of each graph. For example, the graph labeled “−1 mm (+2 mm)” shows the energy intensity distribution at a position 1 mm closer to the optical element of Example 2 than the position corresponding to the focal point A15. In FIG. 8, the position corresponding to the composite focal point 17 is labeled “−3 mm (0 mm)”. The position corresponding to the first irradiation point 16 is labeled “−4 mm (−1 mm)”. It should be noted that the values in parentheses indicate the distances along the optical axis with the composite focal point 17 as the reference (0 mm).

In the graph at the position of “0 mm (+3 mm)”, a single-peaked energy intensity distribution is spread at the central portion of a bimodal energy intensity distribution. That is, the image shape at this position is an “annular shape with a central portion” in which the laser beam emitted from the optical surface A11 forms a circular image at the central portion, and the laser beam emitted from the optical surface B12 forms an annular image, with the circular image overlapping the central portion of the void portion of the annular image. The energy intensity distribution is spread over a diameter of approximately 400 μm.

Next, the graph at the position of “−3 mm (0 mm)” shows a Gaussian energy intensity distribution. That is, the image shape at this position is a “circular” shape in which the laser beam emitted from the optical surface A11 and the laser beam emitted from the optical surface B12 intersect and are combined in substantially the same region.

Next, the graph at the position of “−4 mm (−1 mm)” shows a steep-shaped distribution with high energy intensity at the central portion of a hill-shaped distribution with low energy intensity. That is, the image shape at this position is a “narrow annular shape with a central portion” in which the laser beam emitted from the optical surface A11 forms a circular image at the central portion, and the laser beam emitted from the optical surface B12 forms an annular image, with the circular image overlapping the inner portion of the annular image. Furthermore, it was confirmed that the energy intensity distribution is spread over a diameter of approximately 200 μm, and the diameter is smaller and the energy intensity distribution is more concentrated compared to the energy intensity distribution at the position of “0 mm (+3 mm)”. It was also confirmed that this position, which corresponds to the first irradiation point 16, is located only 1 mm closer to the optical element of Example 2 than the position of “−3 mm (0 mm)”, which corresponds to the composite focal point 17.

Here, the position shifted toward the focal point A15, which is “0 mm (+3 mm)”, from the position of “−3 mm (0 mm)”, which corresponds to the composite focal point 17, is “−2 mm (+1 mm)” or “−1 mm (+2 mm)”. Referring to the graphs at the positions of “−2 mm (+1 mm)” and “−1 mm (+2 mm)”, the energy intensity distribution differs from the “energy intensity distribution in which a steep-shaped distribution with high energy intensity is spread at the central portion of a hill-shaped distribution with low energy intensity”, and the image shape of the energy intensity distribution was not a “narrow annular shape with a central portion”. That is, it was confirmed that the first irradiation point at which the image shape which is a “narrow annular shape with a central portion” is obtained is located on the optical axis on the side opposite to the focal point A15 side with respect to the composite focal point 17, and that the distance along the optical axis from the composite focal point 17 to the first irradiation point 16 is shorter than the distance along the optical axis from the focal point A15 to the composite focal point 17.

It should be noted that the absolute value of the distance along the optical axis from the position corresponding to the composite focal point 17 to the position corresponding to the first irradiation point 16 is 1 mm. Here, since the distance from the optical element of Example 2 to the position corresponding to the focal point A15 (the focal length of the optical surface A) is 200 mm, the distance from the optical element of Example 2 to the composite focal point 17, namely the composite focal length (mm), is 200−3=197 mm. In this case, based on the equation 0.015×|197 mm|=2.955 mm, it was confirmed that the absolute value of the distance along the optical axis from the composite focal point 17 to the first irradiation point 16 falls within the range of 0.015×|composite focal length (mm)| or less.

At the first irradiation point “−4 mm (−1 mm)”, when the maximum energy intensity value in the energy intensity distribution was defined as 100%, an energy distribution diameter A (μm) at 50% energy intensity and an energy distribution diameter B (μm) at 13.5% energy intensity yielded B/A=3.3, satisfying the condition B/A≥2.

Furthermore, it was confirmed that when the peak value of the energy intensity distribution at the position of “−3 mm (0 mm)” corresponding to the composite focal point 17 was defined as 100%, the peak value of the energy intensity distribution at the position of “−4 mm (−1 mm)” corresponding to the first irradiation point 16 was as high as 19.68. On the other hand, the peak value of the energy intensity distribution at the position of “0 mm (+3 mm)” corresponding to the focal point A15 was as low as 4.0%.

### Comparative Example

In the comparative example, the same optical system as that of Example 1 was adopted. As the laser oscillator using a single-mode laser, a single-mode fiber laser FEC1000S (manufactured by FURUKAWA ELECTRIC CO., LTD.) (wavelength: 1070 nm, output: 100 W) was used, and the energy intensity distribution of the laser beam was simulated using OpticStudio, which is provided by Zemax, LLC., along an arbitrary straight line intersecting the optical axis on a plane perpendicular to the optical axis at each position along the optical axis. The simulation results are shown in FIG. 9. In FIG. 9, the vertical axis represents the energy intensity, and the horizontal axis represents the coordinates along an arbitrary straight line including the optical axis on a plane perpendicular to the optical axis. In each graph of FIG. 9, the vertical axis is scaled such that when the peak value of the energy intensity distribution at the position of “−3 mm (0 mm)”, which is 7906.9 kW/cm², was defined as 100%, the peak values of the energy intensity distributions in the other graphs correspond to the intensity values represented by the numerical values noted in the respective graphs. Additionally, in each graph of FIG. 9, the vertical axis scale is adjusted so that the peak values are approximately the same height, and thus the absolute values in each graph differ. In each graph of FIG. 9, the horizontal axis is scaled according to the width described.

In FIG. 9, the energy intensity distribution at the position corresponding to the focal point A15 is shown in the graph labeled “0 mm (+3 mm)” at the top of the graph. Using this position as a reference, the distances along the optical axis approaching the optical element of the comparative example are indicated by the numerical values at the top of each graph. For example, the graph labeled “−1 mm (+2 mm)” shows the energy intensity distribution at a position 1 mm closer to the optical element of the comparative example than the position corresponding to the focal point A15. In FIG. 9, the position corresponding to the composite focal point 17 is labeled “−3 mm (0 mm)”. It should be noted that the values in parentheses indicate the distances along the optical axis with the composite focal point 17 as the reference (0 mm).

In the graph at the position of “0 mm (+3 mm)”, a single-peaked energy intensity distribution is spread at the central portion of a bimodal energy intensity distribution. That is, the image shape at this position is an “annular shape with a central portion”. The energy intensity distribution is spread over a diameter of approximately 200 μm.

Next, the graph at the position of “−3 mm (0 mm)” shows a Gaussian energy intensity distribution.

Next, in Examples 1 and 2, an energy intensity distribution corresponding to an image shape which is a “narrow annular shape with a central portion” was shown at the position of “−4 mm (−1 mm)”. However, in FIG. 9 of the comparative example, the energy intensity distribution at the position of “−4 mm (−1 mm)” exhibited a Gaussian shape, and the image shape which is a “narrow annular shape with a central portion” was not formed. Likewise, the image shape which is a “narrow annular shape with a central portion” was not formed at the positions of “−2 mm (+1 mm)” and “−1 mm (+2 mm)”. At the position of “−4 mm (−1 mm)”, when the maximum energy intensity value in the energy intensity distribution was defined as 100%, an energy distribution diameter A (μm) at 50% energy intensity and an energy distribution diameter B (μm) at 13.5% energy intensity yielded B/A=1.9, which did not satisfy the condition B/A≥2.

### INDUSTRIAL APPLICABILITY

The laser processing apparatus according to the present invention can form an image shape such as a “narrow annular shape with a central portion”, a “Gaussian shape”, or an “annular shape with a central portion” on a plane perpendicular to the optical axis at the irradiation point of the laser beam on the workpiece by selecting a position along the optical axis. In particular, in an image shape which is a “narrow annular shape with a central portion”, the energy intensity at the central portion is close to the energy intensity at the central portion of a Gaussian shape at the composite focal point, and the laser beam at the “central portion” performs laser processing on the workpiece, while the laser beam at the “narrow annular” portion can suppress spatter. Accordingly, by selecting the image shape which is a “narrow annular shape with a central portion”, it is possible to perform: proper laser processing while sufficiently suppressing spatter, even with a laser beam having a lower energy intensity than in the conventional case of an “annular shape with a central portion”. That is, the present invention is suitable for use as a laser processing apparatus that performs processing such as cutting, drilling, or welding on a workpiece by focusing a laser beam and irradiating the workpiece.

1. A laser processing apparatus for processing a workpiece by irradiating a laser beam emitted from a laser oscillator using a multimode laser, wherein
an optical system of the laser processing apparatus includes: an optical element having an optical surface A with a focusing shape which has a focal point A at which a circular region centered on an optical axis and including the optical axis is focused to one point on the optical axis; and an optical surface B which is located on an outer peripheral side of the optical surface A, has a focusing shape, and has a focal point B at which an annular region centered on the optical axis is focused in an annular manner around the optical axis on a plane perpendicular to the optical axis at a position of the focal point A, and
when a point on the optical axis at which a laser beam emitted from the optical surface A and a laser beam emitted from the optical surface B intersect with substantially a same diameter on the optical axis is defined as a composite focal point,
a first irradiation point, which is a position on the optical axis where the laser beam is irradiated onto the workpiece, is located on the optical axis on an opposite side of the composite focal point from the focal point A, and
a distance along the optical axis from the composite focal point to the first irradiation point is shorter than a distance along the optical axis from the focal point A to the composite focal point.

2. The laser processing apparatus according to claim 1, wherein
when a diameter of the laser beam which is incident on the optical element is defined as 100%, the diameter of the optical surface A is 10% or more and 25% or less.

3. The laser processing apparatus according to claim 1, wherein
when a distance from the optical element to the composite focal point is defined as a composite focal length, an absolute value of a distance along the optical axis from the composite focal point to the first irradiation point is 0.015×|composite focal length| or less.

4. The laser processing apparatus according to claim 1, wherein
an image shape of the laser beam at the first irradiation point on a plane perpendicular to the optical axis is formed by overlapping an image formed by the laser beam emitted from the optical surface A onto an inner portion of an image formed by the laser beam emitted from the optical surface B, and
an energy intensity distribution of the laser beam along an arbitrary straight line intersecting the optical axis on a plane perpendicular to the optical axis at the first irradiation point is such that: an image formed by the laser beam emitted from the optical surface B forms a hill-shaped distribution of low energy intensity centered on the optical axis, an image formed by the laser beam emitted from the optical surface A forms a steep-shaped distribution of high energy intensity centered on the optical axis, and the steep-shaped distribution of high energy intensity centered on the optical axis is spread at a central portion of the hill-shaped distribution of low energy intensity centered on the optical axis.

5. The laser processing apparatus according to claim 4, wherein
in the energy intensity distribution of the laser beam along an arbitrary straight line intersecting the optical axis on a plane perpendicular to the optical axis at the first irradiation point, when a maximum energy intensity value is defined as 100%, an energy distribution diameter A at 50% energy intensity and an energy distribution diameter B at 13.5% energy intensity satisfy B/A≥2.

6. The laser processing apparatus according to claim 1, wherein a second irradiation point, which is a position on the optical axis where the laser beam is irradiated onto the workpiece, corresponds to the focal point A,
an image shape of the laser beam on a plane perpendicular to the optical axis at the second irradiation point is formed by overlapping an image formed by the laser beam emitted from the optical surface A onto a central portion of a void portion of an image formed by the laser beam emitted from the optical surface B, and
an energy intensity distribution of the laser beam along an arbitrary straight line intersecting the optical axis on a plane perpendicular to the optical axis at the second irradiation point is such that: an image formed by the laser beam emitted from the optical surface B forms a bimodal energy intensity distribution centered on the optical axis, an image formed by the laser beam emitted from the optical surface A forms a single-peaked energy intensity distribution centered on the optical axis, and the single-peaked energy intensity distribution centered on the optical axis is spread at a central portion of the bimodal energy intensity distribution centered on the optical axis.
